(19) United States
(12) Patent Application Publication
(10) Pub. No.: US 2014/0092104 A1
(43) Pub. Date: Apr. 3, 2014

(54) BOOTING METHOD AND ELECTRONIC DEVICE

(71) Applicant: WISTRON CORPORATION, New Taipei City (TW)

(72) Inventors: Ming-Lan Tsai, New Taipei City (TW); Wei-Min Yang, New Taipei City (TW); Tian-Hao Chen, New Taipei City (TW); Shih-Chang Wang, New Taipei City (TW); Yong-Ting Chen, New Taipei City (TW)

(73) Assignee: Wistron Corporation, New Taipei City (TW)

(21) Appl. No.: 13/886,270

(22) Filed: May 3, 2013

(30) Foreign Application Priority Data
Oct. 3, 2012 (TW) 101136528

(51) Int. Cl. G06F 9/44

(52) U.S. Cl. CPC G06F 9/4405
USPC 345/502

(57) ABSTRACT

A booting method for an electronic device having a display device is provided. The method includes steps of receiving a booting signal and, according to the booting signal, a booting procedure is performed. The booting procedure comprises activating a basic input/output system to read a graphic device variable. According to the graphic device variable, a system configuration of the electronic device is set so that the booting procedure is performed with a first graphic device corresponding to the graphic device variable. When the display device displays a booting frame, an operating system is activated. When there is no frame shown on the display device and a hot-key signal is received, the graphic device variable is rewritten according to the hot-key signal so that the graphic device variable corresponds to a second graphic device. A rebooting procedure is performed on the electronic device.

### CROSS-REFERENCE TO RELATED APPLICATION

This application claims the priority benefit of Taiwan application serial no. 101136528, filed on Oct. 3, 2012. The entirety of the above-mentioned patent application is hereby incorporated by reference herein and made a part of this specification.

### BACKGROUND OF THE INVENTION

1. Field of Invention

The present invention relates to a booting method and an electronic device. More particularly, the present invention relates to a hot-key activated graphic device switching method and an electronic device.

2. Description of Related Art

A computer system mainly comprises a main board, a central processing unit (CPU) and a storage device. When we turn on a computer system, the central processing unit inside the computer will automatically execute a series of commands. According to their functions, these commands can be crudely classified into three major categories, namely, system assembly analysis, power-on self test and loading of an operating system. In a routine booting procedure, information such as the model of the central processing unit, the size of the memory and the type of storage device are analyzed to serve as an important reference for taking other actions. Thereafter, the central processing unit retrieves program codes from the basic input/output system (BIOS) chip on the main board to perform a self test and initializes various hardware devices so that the system can operate normally. Finally, an operating system is loaded and then the control of the computer system is transferred to the operating system at the end of the booting procedure.

In the conventional method during the booting procedure, when the booting frame is not shown on the display device of the computer system due to various factors (including the malfunction of the graphic device), the user either replaces the central processing unit to find out the hardware problem or implements the complex steps of rewriting and compiling the basic input/output system in order to re-perform the booting procedure with the use of another graphic device. However, no matter what method mentioned above is used, the user needs to spend a lot of time to successfully achieve the goal of booting computer system.

### SUMMARY OF THE INVENTION

The present invention is to provide a booting method and a hot-key activated graphic device switching method capable of using the hot key to rapidly switch the graphic device in use in the booting procedure.

The present invention also provides an electronic device capable of rapidly switching the graphic device in use in the booting procedure without performing the complex steps of rewriting and re-compiling the basic input/output system.

The invention provides a booting method for an electronic device having a display device. The method comprises receiving a booting signal and, according to the booting signal, performing a booting procedure. The booting procedure comprises activating a basic input/output system to read a graphic device variable. According to the graphic device variable, a system configuration of the electronic device is set so that the booting procedure is performed with a first graphic device corresponding to the graphic device variable. When the display device displays a booting frame, an operating system is activated. When there is no frame shown on the display device and a hot-key signal is received, the graphic device variable is rewritten according to the hot-key signal so that the graphic device variable corresponds to a second graphic device and the booting procedure is automatically re-performed.

According to one embodiment of the present invention, when the first graphic device is an integrated graphic processing unit, the second graphic device is a discrete graphic processing unit.

According to one embodiment of the present invention, when the first graphic device is a discrete graphic processing unit, the second graphic device is an integrated graphic processing unit.

According to one embodiment of the present invention, the electronic device has a non-volatile memory and the graphic device variable is stored in the non-volatile memory.

The invention also provides a hot-key activated booting graphic device switching method for an electronic device using a first graphic device in a booting procedure and there is no frame shown by a display device of the electronic device. The method comprises receiving a hot-key signal and, according to the hot-key signal, automatically performing a rebooting procedure so that the electronic device performs the booting procedure with the use of the second graphic device.

According to one embodiment of the present invention, when the first graphic device is an integrated graphic processing unit, the second graphic device is a discrete graphic processing unit.

According to one embodiment of the present invention, when the first graphic device is a discrete graphic processing unit, the second graphic device is an integrated graphic processing unit.

According to one embodiment of the present invention, when the electronic device using the first graphic device in the booting procedure, a graphic device variable of the electronic device corresponds to the first graphic device, and the step of automatically performing the rebooting procedure comprises rewriting the graphic device variable so that the graphic device variable corresponds to the second graphic device according to the hot-key signal and re-activating a basic input/output system to read the graphic device variable. According to the graphic device variable, a system configuration of the electronic device is set so that the booting procedure is performed with the second graphic device corresponding to the graphic device variable.

According to one embodiment of the present invention, the electronic device has a non-volatile memory and the graphic device variable is stored in the non-volatile memory.

The invention further provides an electronic device comprises a storage device, a basic input/output system memory, a system main memory and a processing unit. The storage device is used for storing a graphic device variable. The basic input/output system memory is used for storing a basic input/output system. The basic input/output system comprises an initialization module and a hot-key module. The initialization module is used for setting a configuration of the electronic device according to the graphic device variable so that the electronic device perform a booting procedure with the use of a first graphic device corresponding to the graphic device variable. When the electronic device receives a hot-key signal in the booting procedure, the hot-key module is used for rewriting the graphic device variable according to the hot-key signal so that the graphic device variable corresponds to a second graphic device. The processing unit is used for loading the basic input/output system into the system main memory according to a booting signal so as to perform the booting procedure and automatically re-performing the booting procedure after the basic input/output system rewrites the graphic device variable according to the hot-key signal.

According to one embodiment of the present invention, when the first graphic device is an integrated graphic processing unit, the second graphic device is a discrete graphic processing unit.

According to one embodiment of the present invention, when the first graphic device is a discrete graphic processing unit, the second graphic device is an integrated graphic processing unit.

According to one embodiment of the present invention, the storage device includes a non-volatile memory.

Accordingly, at the hardware initialization process in the booting procedure of the electronic device of the present invention, the basic input/output system reads the graphic device variable stored in the storage device to determine to use the graphic device corresponding to the graphic device variable in the booting procedure. When discovering that there is no frame shown on the display device or the display device is at a no-displaying signal state, the user can immediately presses the hot key to generate a hot-key signal. Therefore, the basic input/output system, according to the hot-key signal, rewrites the graphic device variable stored in the storage device so that the graphic device variable is changed to correspond to another graphic device. Meanwhile, the electronic device re-performs the booting procedure with the use of another graphic device according to the changed graphic device variable. Therefore, it is not necessary for the user to go through the complex steps of rewriting and re-compiling the basic input/output system to reach the goal of switching the graphic device in the booting procedure.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a flow chart illustrating a booting method according to one embodiment of the invention.

FIG. 2 is a schematic diagram showing an electronic device according to one embodiment of the present invention.

### DESCRIPTION OF THE PREFERRED EMBODIMENTS

In the present invention, when an electronic device uses a graphic device in a booting procedure and the booting frame is not shown on the display device of the electronic device due to various factors (including the malfunction of the graphic device), the user can press a hot key to generate a hot-key signal to force the electronic device to re-perform the booting procedure with the use of another graphic device. Therefore, unlike the conventional method in which the steps for rewriting and re-compiling the basic input/output system to switch the graphic device in use are complex, the present invention is capable of switching the graphic device in use during the booting procedure and the steps of the present invention are more simple.

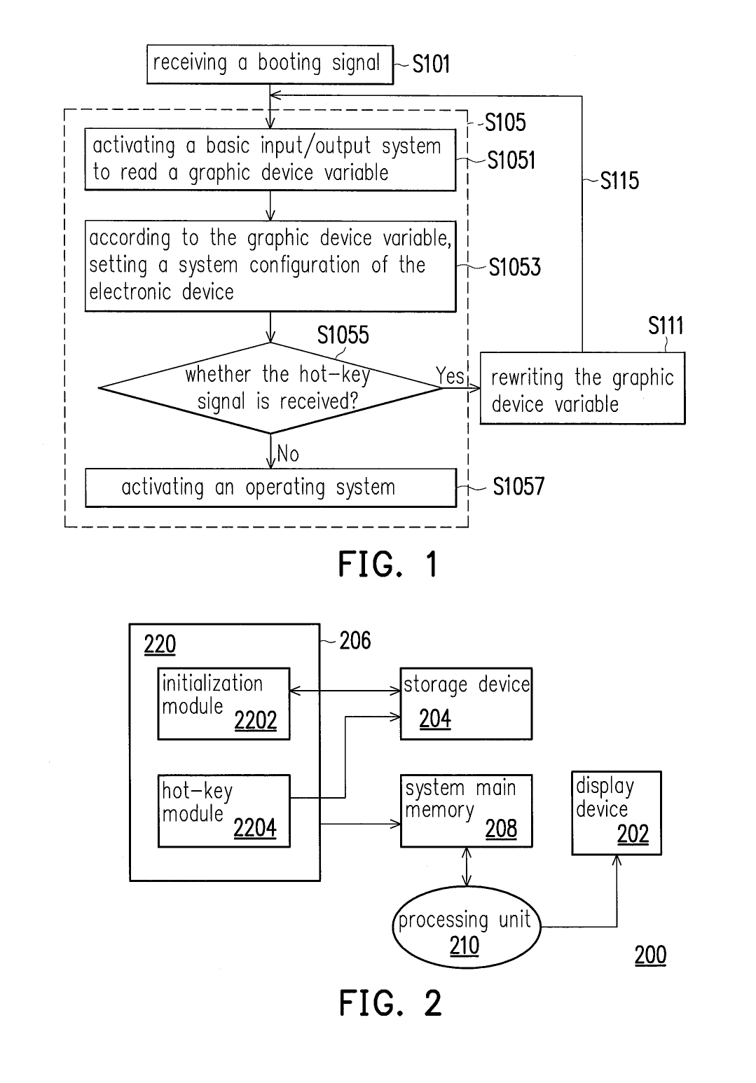

FIG. 1 is a flow chart illustrating a booting method according to one embodiment of the invention. As shown in FIG. 1, the booting method of the present embodiment is implemented by an electronic device having a display device. In the step S101, the electronic device receives a booting signal. Then, according to the booting signal, a booting procedure is performed (step S105).

More specifically, the booting procedure comprises, in the step S1051, activating a basic input/output system to read a graphic device variable. It should be noticed that the electronic device of the present embodiment has a storage device. The storage device can be, for example, a non-volatile memory (such as flash memory) and the aforementioned graphic device variable is stored in this non-volatile memory.

In the step S1053, according to the graphic device variable, a system configuration of the electronic device is set. Noticeably, at this moment in the booting procedure, the basic input/output system performs a hardware initialization process of the electronic device according to the graphic device variable so that the electronic device performs the booting procedure with the use of a first graphic device corresponding to the graphic device variable.

When the display device of the electronic device shows a booting frame, an operating system is activated (step S1057). That is, since the display device of the electronic device shows the booting frame and the user does not press the hot key to generate the hot-key signal, the electronic device does not receive any hot-key signal (step S1055) and the step of activating the operating system is performed (step S1057).

Alternatively, when there is no frame shown on the display device (for instance, no booting frame is shown on the display device) or the display device is at a no-displaying signal state, the user, accordingly, presses the hot key to generate a hot-key signal and the electronic device receives this hot-key signal. According to the hot-key signal, the basic input/output system rewrites the graphic device variable stored in the storage device so that the graphic device variable which originally corresponds to the first graphic device is changed to correspond to a second graphic device (step S111). It should be noticed that when the aforementioned first graphic device is the integrated graphic processing unit (IGPU), the second graphic device is the discrete graphic processing unit (DGPU). Alternatively, when the first graphic device is the discrete graphic processing unit, the second graphic device is the integrated graphic processing unit.

Then, the electronic device automatically re-performs the aforementioned booting procedure (step S115). More specifically, the electronic device re-activates the basic input/output system and the basic input/output system re-read the graphic device variable stored in the storage device (step S1051), and, meanwhile, the graphic device variable has been changed to correspond to the second graphic device in the aforementioned step S111. Thereafter, according to the changed graphic device variable, the system configuration of the electronic device is set to use the second graphic device corresponding to the graphic device variable in the booting procedure (step S1053) and then the operating system is activated under the situation that the same display device is still connected to the electronic device and is still utilized by the electronic device to show the booting frame and the frame of the operating system (step S1057).

FIG. 2 is a schematic diagram showing an electronic device according to one embodiment of the present invention. As shown in FIG. 2, an electronic device 200 of the present embodiment comprises a display device 202, a storage device 204, a basic input/output system memory 206, a system main memory 208 and a processing unit 210. The storage device 204 stores a graphic device variable. Moreover, the storage device 204 comprises a non-volatile memory such as the flash memory. The display device 202 receives the video signal from the processing unit 210 to display frames. The basic input/output system memory 206 stores a basic input/output system 220. The basic input/output system memory 206 includes a non-volatile memory such as a flash memory. The processing unit 210, according to a booting signal, loads the basic input/output system 220 into the system main memory 208 to perform a booting procedure.

It should be noticed that the basic input/output system 220 further comprises an initialization module 2202 and a hot-key module 2204. The initialization module 2202, according to the graphic device variable stored in the storage device 204, sets a system configuration of the electronic device 200 so that the electronic device 200 perform a booting procedure with the use of a first graphic device corresponding to the graphic device variable. The hot-key module 2204 of the electronic device 200, in the booting procedure, rewrites the graphic device variable stored in the storage device 204 according to the hot-key signal so that the graphic device variable corresponds to a second graphic device when there is no frame (such as the booting frame) shown on the display device due to unknown factors or the malfunction of the first graphic device or the display device is at a no-displaying signal state and the electronic device receives a hot-key signal generated by the user pressing the hot key. Therefore, the graphic device variable which is originally corresponding to the first graphic device is changed to correspond to a second graphic device. After the electronic device 200 receives the hot-key signal and the hot-key module 2204 of the basic input/output system 220 rewrites the graphic device variable, the processing unit 210 re-performs the booting procedure with the use of the same display device. When the first graphic device is an integrated graphic processing unit, the second graphic device is a discrete graphic processing unit. Alternatively, when the first graphic device is a discrete graphic processing unit, the second graphic device is an integrated graphic processing unit.

Altogether, at the hardware initialization process in the booting procedure of the electronic device of the present invention, the basic input/output system reads the graphic device variable stored in the storage device to determine to use the graphic device corresponding to the graphic device variable in the booting procedure. When discovering that there is no frame shown on the display device or the display device is at a no-displaying signal state, the user can immediately presses the hot key to generate a hot-key signal. Therefore, the basic input/output system, according to the hot-key signal, rewrites the graphic device variable stored in the storage device so that the graphic device variable is changed to correspond to another graphic device. Meanwhile, the electronic device re-performs the booting procedure with the use of another graphic device according to the changed graphic device variable. Therefore, it is not necessary for the user to go through the complex steps of rewriting and re-compiling the basic input/output system to reach the goal of switching the graphic device in the booting procedure.

It will be apparent to those skilled in the art that various modifications and variations can be made to the structure of the present invention without departing from the scope or spirit of the invention. In view of the foregoing descriptions, it is intended that the present invention covers modifications and variations of this invention if they fall within the scope of the following claims and their equivalents.

What is claimed is:

1. A booting method for an electronic device having a display device, the method comprising:
receiving a booting signal;
according to the booting signal, performing a booting procedure, wherein the booting procedure comprises:
activating a basic input/output system to read a graphic device variable;
according to the graphic device variable, setting a system configuration of the electronic device so that the booting procedure is performed with a first graphic device corresponding to the graphic device variable;
when the display device displays a booting frame, activating an operating system;
when there is no frame shown on the display device and a hot-key signal is received, rewriting the graphic device variable according to the hot-key signal so that the graphic device variable corresponds to a second graphic device; and
automatically re-performing the booting procedure on the electronic device.

2. The booting method of claim 1, wherein when the first graphic device is an integrated graphic processing unit, the second graphic device is a discrete graphic processing unit.

3. The booting method of claim 1, wherein when the first graphic device is a discrete graphic processing unit, the second graphic device is an integrated graphic processing unit.

4. The booting method of claim 1, wherein the electronic device has a non-volatile memory and the graphic device variable is stored in the non-volatile memory.

5. A hot-key activated booting graphic device switching method for an electronic device using a first graphic device in a booting procedure, wherein there is no frame shown by a display device of the electronic device, the method comprising:
receiving a hot-key signal;
according to the hot-key signal, automatically performing a rebooting procedure so that the electronic device performs the booting procedure with the use of the second graphic device.

6. The hot-key activated booting graphic device switching method of claim 5, wherein when the first graphic device is an integrated graphic processing unit, the second graphic device is a discrete graphic processing unit.

7. The hot-key activated booting graphic device switching method of claim 5, wherein when the first graphic device is a discrete graphic processing unit, the second graphic device is an integrated graphic processing unit.

8. The hot-key activated booting graphic device switching method of claim 5, wherein when the electronic device using the first graphic device in the booting procedure, a graphic device variable of the electronic device corresponds to the first graphic device, and the step of automatically performing the rebooting procedure comprises:
according to the hot-key signal, rewriting the graphic device variable so that the graphic device variable corresponds to the second graphic device;
re-activating a basic input/output system to read the graphic device variable; and
according to the graphic device variable, setting a system configuration of the electronic device so that the booting procedure is performed with the second graphic device corresponding to the graphic device variable.

9. The hot-key activated booting graphic device switching method of claim 8, wherein the electronic device has a non-volatile memory and the graphic device variable is stored in the non-volatile memory.

10. An electronic device, comprising:
a storage device, storing a graphic device variable;
a basic input/output system memory, storing a basic input/output system, wherein the basic input/output system comprises:
an initialization module, setting a configuration of the electronic device according to the graphic device variable so that the electronic device perform a booting procedure with the use of a first graphic device corresponding to the graphic device variable;
a hot-key module, wherein, in the booting procedure, when the electronic device receives a hot-key signal, the hot-key module rewrites the graphic device variable according to the hot-key signal so that the graphic device variable corresponds to a second graphic device;
a system main memory; and
a processing unit, loading the basic input/output system into the system main memory according to a booting signal so as to perform the booting procedure and automatically re-performing the booting procedure after the basic input/output system rewrites the graphic device variable according to the hot-key signal.

11. The electronic device of claim 10, wherein when the first graphic device is an integrated graphic processing unit, the second graphic device is a discrete graphic processing unit.

12. The electronic device of claim 10, wherein when the first graphic device is a discrete graphic processing unit, the second graphic device is an integrated graphic processing unit.

13. The electronic device of claim 10, wherein the storage device includes a non-volatile memory.
